(19) United States
(12) Patent Application Publication
(10) Pub. No.: US 2026/0277980 A1
(43) Pub. Date: Sep. 17, 2026

(54) EXPERT-AWARE RETRIEVAL AUGMENTED GENERATION

(71) Applicant: NVIDIA Corporation, Santa Clara, CA (US)

(72) Inventors: Abhinav Balasubramanian, Santa Clara, CA (US); Rama Kalyani Akkiraju, Cupertino, CA (US); Anbang Xu, San Jose, CA (US); Tan Yu, San Jose, CA (US); Shivakesh Reddy Annepally, San Ramon, CA (US); Paramaguru Muthusamy, Fremont, CA (US); Lei Yang, San Jose, CA (US); Pritam Gundecha, San Jose, CA (US); Nicholas Burnett, Silver Spring, MD (US); Meghana Puvvadi, Santa Clara, CA (US); Deepak Bora, San Ramon, CA (US)

(73) Assignee: NVIDIA Corporation, Santa Clara, CA (US)

(21) Appl. No.: 19/405,244

(22) Filed: Dec. 1, 2025

Related U.S. Application Data
(60) Provisional application No. 63/770,161, filed on Mar. 11, 2025.

(51) Int. Cl. G06F 16/34; G06F 16/334; G06F 16/35; G06F 16/38

(52) U.S. Cl. CPC G06F 16/345; G06F 16/3347; G06F 16/35; G06F 16/38

(57) ABSTRACT

In various examples, an enhanced retrieval-augmented generation (RAG) system may provide relevant responses to user queries by prioritizing contextually relevant information based on author-related metadata. For instance, the systems and methods of the present disclosure may enrich documents—or portions (e.g., “chunks”) thereof—with metadata indicating an author's role, expertise, or association with a customer or topic. Upon receiving a query, the RAG system may retrieve content using keyword and/or semantic search, and prioritize results based on expert relevance. In some examples, threshold-based filtering or expert relationship graphs may be used to improve retrieval quality and reduce processing costs. Retrieved documents may, in some instances, be broken into smaller parts and summarized in parallel, with intermediate summaries recursively condensed to fit within a language model's context window. A final answer may then be generated using the user query and the refined summary.

### CROSS-REFERENCE TO RELATED APPLICATIONS

This application claims the benefit of U.S. Provisional Application No. 63/770,161, filed on Mar. 11, 2025, which is hereby incorporated by reference in its entirety and for all purposes.

### BACKGROUND

Generative artificial intelligence (AI) systems—and in particular, those using language models—are increasingly deployed in a wide variety of applications that may require generating outputs based on large volumes of data. In such systems, retrieval-augmented generation (RAG) has emerged as a prominent technique for grounding AI model responses in external content by combining document retrieval with language generation. For instance, a RAG system may be used to answer complex user queries by retrieving relevant information from a document index and then passing that information to a language model or other generative AI model that is configured to generate a response. Because many AI models are limited to processing a finite amount of data at once, some systems may attempt to reduce input length by breaking long documents into smaller parts prior to generation-a process experts often refer to as “chunking.”

However, conventional RAG systems often fall short when applied to large, heterogeneous datasets that include varying levels of detail, authorship, and domain expertise. For instance, conventional RAG systems typically treat retrieved content as equally relevant, without accounting for differences in source credibility, organizational role, or contextual importance. As a result, the generated outputs may reflect surface-level patterns or redundant information, while overlooking more relevant or insightful content. In addition, conventional solutions may rely on static retrieval or precomputed summaries, which may not adapt well to the specific intent or focus of a user's query. This lack of dynamic, query-aware processing can lead to irrelevant, fragmented, or low-quality responses-especially in enterprise settings where the underlying data may span hundreds or thousands of documents authored by different individuals.

### SUMMARY

Embodiments of the present disclosure relate to expert-aware retrieval augmented generation (RAG). Systems and methods are disclosed for enhancing RAG pipelines and providing relevant responses to user queries by prioritizing retrieved content based on author-related metadata such as role, expertise, or topic association. In some examples, the disclosed techniques may also include hybrid retrieval mechanisms, expert-guided filtering, and document storage structures that support semantic indexing and query-aware summarization.

For instance, the systems and methods of the present disclosure may enrich documents—or portions thereof (e.g., “chunks”)—with metadata that identifies, among other things, the author and/or the author's role, expertise, or association with a customer, project, or topic. Upon receiving a query, the disclosed systems may perform keyword-based, semantic, or hybrid retrieval to identify content relevant to the query, and may apply ranking techniques that prioritize content linked to domain experts or organizational relevance. In some examples, the systems may construct or reference an author-entity relationship graph to support expert-guided reranking and apply threshold-based logic to halt retrieval when additional results are unlikely to improve response quality. Retrieved content may, in some instances, be broken into smaller parts and summarized in parallel, with intermediate summaries recursively combined into a final condensed representation suitable for input to a language model. A final response may be generated using the query and the condensed content, thereby producing an output that is both contextually grounded and expertise-aware.

In contrast to conventional systems, the systems and methods of the present disclosure, in some embodiments, are able to generate more accurate, contextually grounded, and expert-relevant responses to user queries, particularly when operating over large and diverse document collections. For instance, by leveraging author-related metadata and expert relationship graphs during retrieval and ranking, the disclosed systems and methods are able to prioritize content from knowledgeable or contextually significant sources. Unlike traditional RAG systems that may rely solely on surface-level similarity or static retrieval pipelines, the disclosed techniques may dynamically adapt to the query intent and selectively retrieve and summarize information in a way that emphasizes expertise and reduces redundancy, thereby improving both the quality and efficiency of the generated output. Additionally, the disclosed systems and methods are able to reduce computational overhead through threshold-based retrieval strategies and support flexible integration with different storage backends, enabling scalable and efficient deployment across various enterprise and domain-specific environments.

### BRIEF DESCRIPTION OF THE DRAWINGS

The present systems and methods for expert-aware retrieval augmented generation (RAG) are described in detail below with reference to the attached drawing figures, wherein:

FIG. 1 is a system-level block diagram showing an example of a generalized pipeline associated with an expert-aware RAG system, in accordance with some embodiments of the present disclosure;

FIG. 2 is a data flow diagram illustrating an example ingestion and enrichment process that may be performed by the expert-aware RAG system, in accordance with some embodiments of the present disclosure;

FIG. 3 is a data flow diagram illustrating an example retrieval process using keyword and semantic search over metadata-enriched document chunks, in accordance with some embodiments of the present disclosure;

FIG. 4 is a data flow diagram illustrating an example process that may be performed by the agentic RAG system to generate a response to a user query, in accordance with some embodiments of the present disclosure;

FIG. 5 is a data flow diagram illustrating an example branching flow for handling different types of user queries within the agentic RAG system, in accordance with some embodiments of the present disclosure;

FIG. 6 is a flow diagram illustrating an example of a method for expert-aware content enrichment, retrieval, and response generation, in accordance with some embodiments of the present disclosure;

FIG. 7 is a flow diagram illustrating an example of a method for generating query responses using author-aware relevance scoring, in accordance with some embodiments of the present disclosure;

FIG. 8A is a block diagram of an example generative language model system suitable for use in implementing at least some embodiments of the present disclosure;

FIG. 8B is a block diagram of an example generative language model that includes a transformer encoder-decoder suitable for use in implementing at least some embodiments of the present disclosure;

FIG. 8C is a block diagram of an example generative language model that includes a decoder-only transformer architecture suitable for use in implementing at least some embodiments of the present disclosure;

FIG. 9 is a block diagram of an example computing device suitable for use in implementing at least some embodiments of the present disclosure; and

FIG. 10 is a block diagram of an example data center suitable for use in implementing at least some embodiments of the present disclosure.

### DETAILED DESCRIPTION

Systems and methods are disclosed related to expert-aware retrieval augmented generation (RAG). In some examples, the disclosed systems and methods may enrich documents with author-related metadata, store enriched content in structured formats to support both keyword and semantic search, apply expert-aware filtering and reranking strategies to retrieved results, and use summarization pipelines tailored to user queries. These components may work together to generate responses to queries that are more relevant, contextually-aware, and grounded in domain expertise than those produced by conventional RAG systems. In some embodiments, retrieved content may be evaluated and ranked using an alignment score-a numerical value representing the degree of association between an author of a document and the subject of the query. Documents with low alignment scores may be excluded to ensure that results are both topically relevant and authored by domain-appropriate contributors.

For instance, a system(s) may obtain content or other unstructured data from one or more sources. The content may include, but is not limited to, internal documents, public reports, web content, trip summaries, email logs, research articles, or any other form of textual, audio, or image-based information. The system(s) may parse the content to identify structural boundaries, semantic sections, and templated patterns, and then divide the content into semantically meaningful portions—such as paragraphs, sections, or other logical units—based on natural breakpoints or content-aware heuristics. For example, a multi-page travel report may be split into smaller portions (chunks) corresponding to distinct activities, such as a stakeholder meeting, a field observation, or a product demo, one or more (e.g., each) of which may hold independent relevance for later queries. Additionally, the system(s) may enrich one or more (e.g., each) of the portions with information (e.g., metadata) derived from the surrounding context or external information, including the identity of the author, the author's role, domain expertise, affiliation, or association with a relevant topic or subject area. Metadata may also include structured indicators of expertise levels or topical relationships derived from a contributor-subject knowledge graph. As an example, a document authored by a field technician describing equipment performance may be tagged with metadata indicating the author's technical background and their connection to a specific customer deployment, allowing later queries to prioritize it over more general content.

As described herein, in various examples, the system(s) may store the information-enriched documents or portions in one or more databases or other storage systems. The database(s) may, in some instances, support both keyword-based and semantic (e.g., vector-based) search operations, allowing content to be retrieved based on textual similarity, embedding proximity, and/or exact term matches. In some examples, the database(s) may also support hybrid search strategies that combine multiple retrieval signals to improve relevance. One or more (e.g., each) of the stored documents or document portions may be associated with metadata fields, unique identifiers, and other indexing information to facilitate efficient filtering, ranking, or aggregation. Additionally, the storage system may enable partitioning or tagging of content by source, author, time range, subject matter, or other organizational dimensions, thereby supporting more targeted retrieval and reducing the computational cost of downstream processing.

Upon receiving a user query, the system(s) may retrieve one or more enriched documents or document portions from the database(s) using keyword-based, semantic, or hybrid retrieval techniques. For example, if a user submits a query such as “recommendations for improving reliability in electric vehicle charging infrastructure,” the system(s) may retrieve internal technical reports, engineering field notes, planning documents, or customer case studies that discuss reliability issues, proposed improvements, or real-world deployment data related to electric vehicle charging. These documents/content may vary in specificity or depth, and may have been authored by different individuals across engineering, operations, or customer success teams.

In the case of semantic retrieval, the system(s) may generate an embedding—a numerical representation or vector—of the query, and compare it against precomputed embeddings of the stored documents/portions to identify content that is semantically similar, even if exact keywords do not match. For keyword-based retrieval, the system(s) may tokenize the query and search for overlapping terms within indexed fields of the stored content, such as titles, body text, or metadata. In some examples, a hybrid retrieval approach may be used, in which the system(s) may combine semantic similarity scores and keyword overlap signals to rank or filter results more effectively. For example, if a user submits a query such as “impact of vendor outage on customer feedback,” the system(s) may retrieve relevant portions that mention outages and customer sentiment—even if the exact phrase does not appear—by identifying semantically related concepts such as “service disruption,” “client complaints,” or “system downtime.” This flexibility may allow the system(s) to locate meaningful information that traditional keyword matching alone may miss.

In some examples, the system(s) may filter or rank (e.g., re-rank) the retrieved content based on information (e.g., metadata) associated with the content's origin, context, or source. For instance, the system(s) may evaluate one or more relevance signals derived from metadata such as the author's role, domain expertise, organizational affiliation, or association with a relevant project or topic. Additional signals may include document-level context such as publication recency, document type (e.g., technical memo vs. executive summary), or known relationships between contributors and subject matter entities. For example, in response to the query about improving reliability in electric vehicle charging infrastructure, the system(s) may prioritize content authored by reliability engineers, deployment leads, or contributors closely tied to relevant field trials, while deprioritizing general planning documents or third-party commentary. In some examples, the system(s) may reference an author-entity or contributor-topic relationship graph to identify indirect expertise and adjust the ranking or alignment score accordingly. The alignment score may reflect the closeness of association between an author and the query subject, computed based on graph distance, co-occurrence frequency, or expertise tag similarity. Documents with alignment scores below a configurable threshold may be removed during ranking or reranking to ensure topical fidelity. This expert- and context-aware prioritization may help ensure that the selected content is both relevant to the query and grounded in credible, experience-based sources.

In some embodiments, the reranking process may involve the system(s) assigning numerical scores (e.g., alignment scores) to one or more (e.g., each) retrieved document portions based on a combination of factors, such as subject matter alignment, author authority, contextual relevance to the user's query, or other factors. The system(s) may then use the scores to generate a new ranked list, reordering the results to surface content that is more likely to contribute meaningful or accurate information in the final response. This approach may differ from simple filtering in that it may retain a broader set of results, but strategically prioritize the relevant entries. For example, consider a scenario in which a query asks about charger reliability issues in urban deployments. The system(s) may retrieve fifteen relevant chunks, but reranking may elevate five documents authored by electrical engineers who led urban site evaluations to the top of the list above more generic status updates or summaries written by support staff. This may ensure that high-quality, experience-based content is made more visible to downstream summarization and generation components, even when many sources might address the same general topic.

The system(s) may, in some instances, perform one or more filtering or pruning operations to reduce redundancy, limit irrelevant content, and/or improve processing efficiency. In some examples, the system(s) may use threshold-based techniques to stop incorporating additional content results once their relevance scores (e.g., relevance scores of the retrieved content) fall below a defined value or drop off sharply relative to higher-ranked content. This threshold may include or incorporate the alignment score to ensure that retained documents are not only semantically similar but also authored by contributors with meaningful associations to the query subject. This may help ensure that the more meaningful information is retained for subsequent summarization and generation. As an example, if the top five documents about EV charging reliability are authored by field engineers and contain highly detailed deployment data, the system(s) may avoid including lower-ranked documents written by general analysts whose content may simply tangentially relate to the query. Additionally, or alternatively, the system(s) may evaluate the diversity or overlap among the retrieved content to filter out duplicate or highly similar entries. For instance, if multiple documents describe the same recommended fix—such as replacing a specific hardware component—the system(s) may retain the more comprehensive or credible version to avoid unnecessary repetition in the generated response.

Additionally, in some examples, the system(s) may reference one or more graphs (e.g., an author-entity and/or topic relationship graph) to determine whether the retrieved content provides sufficient topical coverage or expert representation. The graph(s) may capture known associations between authors, topics, projects, or organizational units, and may be used to infer how closely a given piece of content is connected to the subject of the query. For instance, if the query relates to EV charging reliability, and the system(s) identifies that multiple retrieved reports are authored by individuals connected to a particular deployment team or project node within the graph, the system(s) may infer that the topic has been thoroughly represented. In such cases, additional documents from loosely connected sources may be deprioritized and/or excluded. As another example, if the system(s) determines that three separate engineering teams have independently described the same root cause of a charging failure—such as a firmware bug in a power controller—the system(s) may stop retrieving additional content on that issue, recognizing that expert consensus has been established. By narrowing the retrieved content in this manner, the system(s) may reduce computational overhead, minimize redundancy, and maintain a high level of topical relevance and expert grounding in the final response.

As described herein, in various examples, the system(s) may perform one or more summarization operations to condense the retrieved content (e.g., documents, document portions, etc.) into a shorter, contextually relevant representation that can be efficiently processed by one or more language models or other AI models. In some examples, the summarization process may include the system(s) following a map-reduce strategy in which individual portions of content are first summarized independently to create intermediate representations, which may then be recursively merged or condensed into a final summary. This approach may be particularly useful when dealing with large result sets that exceed the input size limitations of the underlying language model(s). For instance, if ten documents related to electric vehicle charging reliability are selected—including deployment notes, engineering analyses, and failure reports—the system(s) may first generate short summaries of one or more (e.g., each) of the documents, and then combine those summaries into a single, coherent representation that captures the more important and diverse insights across all sources. By summarizing incrementally and hierarchically, the system(s) may preserve key information while minimizing input length, thereby improving the efficiency and quality of the final response.

In some examples, the system(s) may begin the summarization process by generating intermediate summaries for one or more (e.g., each) of the selected document portions. The intermediate summaries may be generated in parallel, allowing the system(s) to efficiently process large batches of content while maintaining responsiveness. In some instances, one or more (e.g., each) of the summaries may be designed to preserve the core message or factual content of its corresponding portion, while omitting repetitive or tangential material. For instance, and still continuing the example from above, a multiple page field report describing various charging reliability tests may be condensed into a few sentences highlighting test outcomes, failure modes, and recommended fixes. Similarly, a case study authored by a customer success team may be distilled to focus on observed reliability issues and customer-reported satisfaction metrics. The intermediate summaries may serve as inputs to downstream condensation stages, where they may be further combined and refined to produce a final, context-aware summary suitable for input to the language model(s).

Following intermediate summarization, the system(s) may iteratively condense the resulting summaries into a final, aggregated representation that fits within the input constraints of the language model(s). In some examples, this may involve recursively combining groups of intermediate summaries into progressively shorter and more cohesive summaries—each stage preserving the most salient points from the previous one. This hierarchical condensation process may be guided by relevance to the original query, thematic diversity, or coverage of key entities and events. Continuing the example of above, summaries describing electric vehicle charger reliability issues from different deployment teams may be merged into a single unified summary that highlights common patterns (e.g., hardware failures in specific climates), while preserving team-specific nuances where relevant. This approach may help maintain a high level of factual density and minimize loss of context, especially in scenarios where the original retrieved content spans multiple authors, formats, and/or technical domains.

In some examples, the system(s) may perform query-aware summarization techniques to further tailor the condensed output to the user's intent. For instance, rather than generating generic summaries, the system(s) may dynamically construct summarization prompts that emphasize elements of the query—such as specific topics, entities, or desired outcomes—which may help ensure that the resulting summary reflects what the user is actually looking for. For example, if a user submits a query asking for “recommendations for improving reliability in electric vehicle charging infrastructure,” the system(s) may instruct the summarization model to focus specifically on recommendations and reliability-related insights, rather than general deployment information or peripheral topics. This targeted approach may help reduce noise, improve answer relevance, and ensure that critical details are retained in the final input to the language model(s).

Once the final summary has been constructed, the system(s) may use it—along with the original user query—as an input prompt to one or more language models or other generative AI models to produce a final response. The language model(s) may be configured to synthesize information from the refined summary, infer logical relationships, and articulate a coherent, natural-language answer that addresses the user's informational need. In some examples, the prompt provided to the model(s) may include additional instructions or formatting preferences, such as emphasizing action items, explaining technical tradeoffs, or presenting the response in a question-and-answer format. For example, in response to a query about improving electric vehicle charger reliability, the final output may present a ranked list of suggested interventions, each supported by evidence drawn from deployment reports and expert-authored field notes. This final generation stage may thus enable the system(s) to deliver responses that are both grounded in retrieved evidence and articulated in a user-friendly manner.

In some examples, the system(s) may perform one or more post-processing operations on the generated output prior to presentation to the user. For instance, the system(s) may apply formatting rules, organize the response into bullet points or sections, or highlight the specific source content that contributed to various portions of the response. Additionally, confidence scores may be generated based on the provenance, consistency, or alignment of retrieved content, and presented alongside the response to support user trust and interpretability. In certain embodiments, users may be given the option to rate, edit, or refine the output, and such feedback may be logged or used to improve future retrieval or ranking behavior-either through fine-tuning or updating metadata weights. These capabilities may help further align the system's responses with user expectations while enabling continuous improvement.

In some embodiments, the systems and methods described herein may be deployed in an interactive or smart assistant application, such as a kiosk, tablet, smart display, or other computing interface. For example, such a device may include one or more onboard processors (e.g., CPUs, GPUs, deep learning accelerators, or SoCs) and memory and/or storage for executing retrieval, ranking, or summarization logic and storing relevant models or metadata. In some cases, the device may communicate—via one or more network interface cards (NICs), data processing units (DPUs), or other communication hardware—with one or more local servers and/or remotely located servers (e.g., hosted in a data center or cloud environment). In these examples, the device may interface with components of the expert-aware RAG system-such as language models, document databases, or vector indexes-through one or more application programming interfaces (APIs), including but not limited to REST APIs or other standardized interfaces. This configuration may allow real-time user queries to be processed through the full retrieval and generation pipeline, delivering expert-aware, contextually grounded responses directly to the user-facing device.

In one or more embodiments, the systems and methods described herein may be deployed in a gaming environment to support dynamic, context-aware query responses or in-game assistance. For example, a gaming console, PC, tablet, or other gaming device may include one or more onboard and/or remote processors (e.g., CPUs, GPUs, deep learning accelerators, or SoCs), as well as memory and/or storage for executing retrieval, ranking, and language generation components. These devices may leverage one or more machine learning models (e.g., transformer-based language models, vision-language models (VLMs), or multi-modal large language models (MMLMs)) to provide players with expert-informed guidance, generate in-game explanations, or surface relevant background knowledge in response to player queries or interactions. In some embodiments, the system(s) may be deployed in a cloud gaming environment, where the core retrieval and generation logic executes on remote infrastructure (e.g., cloud-based servers or data centers). In such cases, a client device—such as a smart display, controller, or headset—may be used to capture user queries or inputs, while the expert-aware RAG system processes the inputs, retrieves relevant information, and generates an appropriate response or in-game asset. The client device may then receive the generated content via a communication interface that includes, for example, one or more network interface cards (NICs) and/or data processing units (DPUs). This architecture may enable responsive, real-time delivery of expert-informed insights or assistance without requiring the full model stack to run locally on the player's device.

In some embodiments, the systems and methods described herein may be deployed in a video conferencing or virtual collaboration application. For example, a video conferencing device—such as a dedicated conferencing unit, computer, tablet, or smartphone—may include one or more onboard processors (e.g., CPUs, GPUs, deep learning accelerators, or SoCs), along with memory and/or storage configured to store audio, video, text, or other meeting-related data. These devices may use one or more machine learning models (e.g., transformer-based language models, large language models (LLMs), vision-language models (VLMs), or multi-modal models (MMLMs)) to support intelligent meeting interactions. In such deployments, the expert-aware retrieval augmented generation (RAG) system may provide real-time, query-driven insights during or after meetings by retrieving and generating contextually relevant information. For instance, a participant may ask, “What were the recommendations from the last customer deployment review?” and the system may retrieve enriched documents authored by subject-matter experts and generate a concise summary within the conferencing interface. In some examples, the system may also support natural language interactions for meeting scheduling, action item summarization, or retrospective search across prior meetings and documents. In certain embodiments, processing may be distributed between local devices and remote servers or data centers, where the language models and enriched document stores are hosted. Communication between the client device and backend infrastructure may use one or more data processing units (DPUs) and/or network interface cards (NICs) to transmit user inputs, retrieve results, and return generated responses in real time or near real time.

In some embodiments, the systems and methods described herein may be deployed in an in-vehicle infotainment (IVI) system or in-cabin experience (IX) application. For example, an infotainment system within a vehicle—such as a car, truck, semi-autonomous vehicle, autonomous vehicle, drone, or robotic system—may include one or more onboard processors (e.g., CPUs, GPUs, deep learning accelerators, vision accelerators, SoCs, etc.) and associated memory and/or storage for maintaining navigation data, user preferences, and machine learning models. In such deployments, the expert-aware RAG system may enable voice-based or multimodal interaction with the vehicle's interface to support contextually relevant responses to user queries. For example, a user may ask, “What's the latest update from engineering about battery reliability in this model?” and the system may retrieve relevant expert-authored content (e.g., field test reports or technical updates) from connected databases and generate a concise, experience-grounded response. The system may also support proactive alerts or recommendations derived from expert-filtered sources in response to sensor-detected issues or driver queries. In some implementations, one or more of the language models, enriched document stores, or expert-ranking systems may be deployed locally on the vehicle's computing platform, or accessed via cloud-based APIs using network connectivity. Data transmission between the vehicle and backend systems may use network interface cards (NICs), data processing units (DPUs), or other communication hardware to enable real-time or near real-time retrieval and response.

Although examples may be described herein with respect to using generative AI models, such as language models, this is not intended to be limiting. For example, and without limitation, any of the various AI models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), small language models (SLMs), vision language models (VLMs), multi-modal language models (MMLMs), large action models (LAMs), vision-language-action (VLA) models, etc.), and/or other types of generative AI models.

In some examples, the generative AI models (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the AI model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the AI model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The AI model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the AI model(s) (e.g., that has been optimized for high performance inference), an inference runtime software to execute the AI model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the AI model(s). When replacing or updating, the software that performs the replacement/updating may maintain user configurations of the inference runtime software and enterprise management software.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

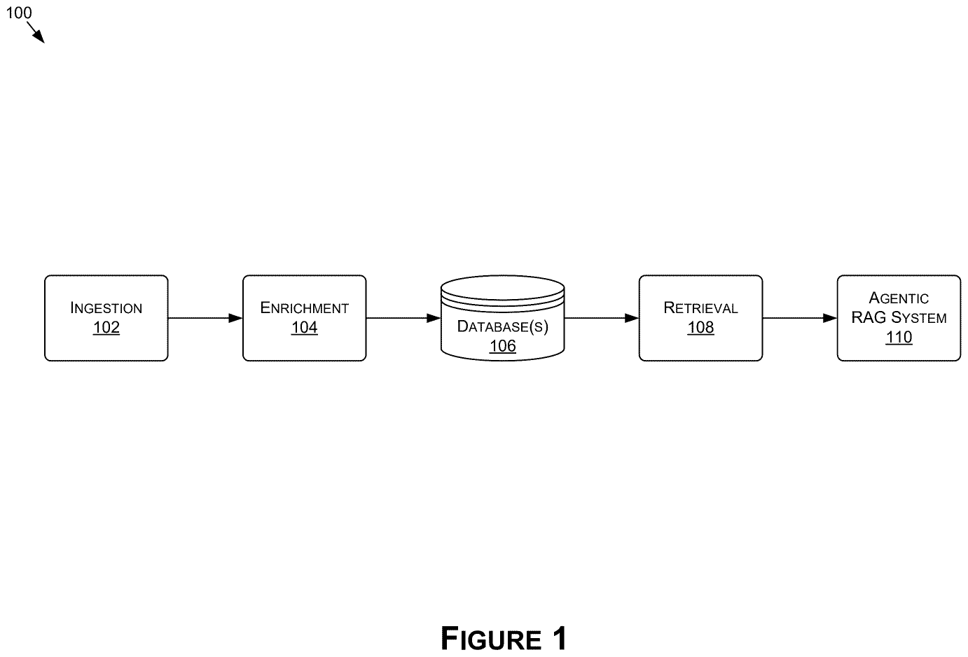

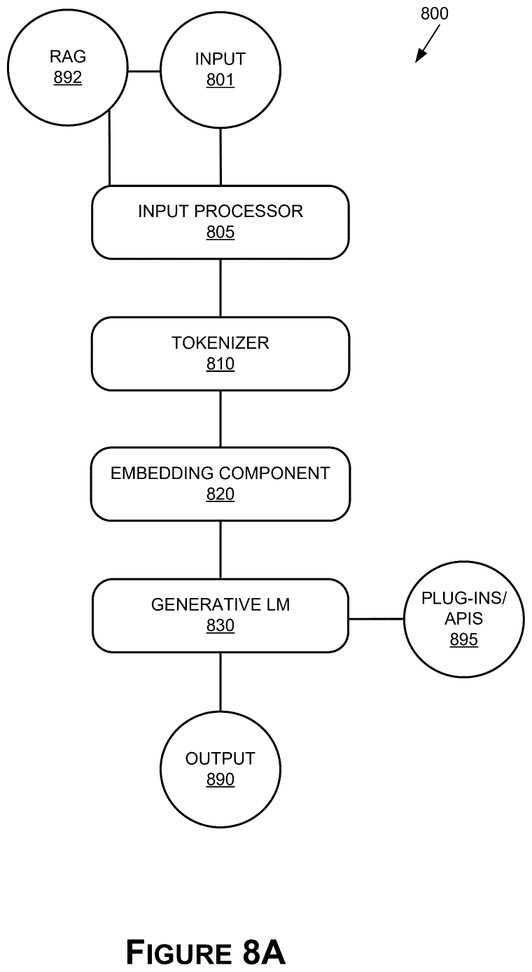

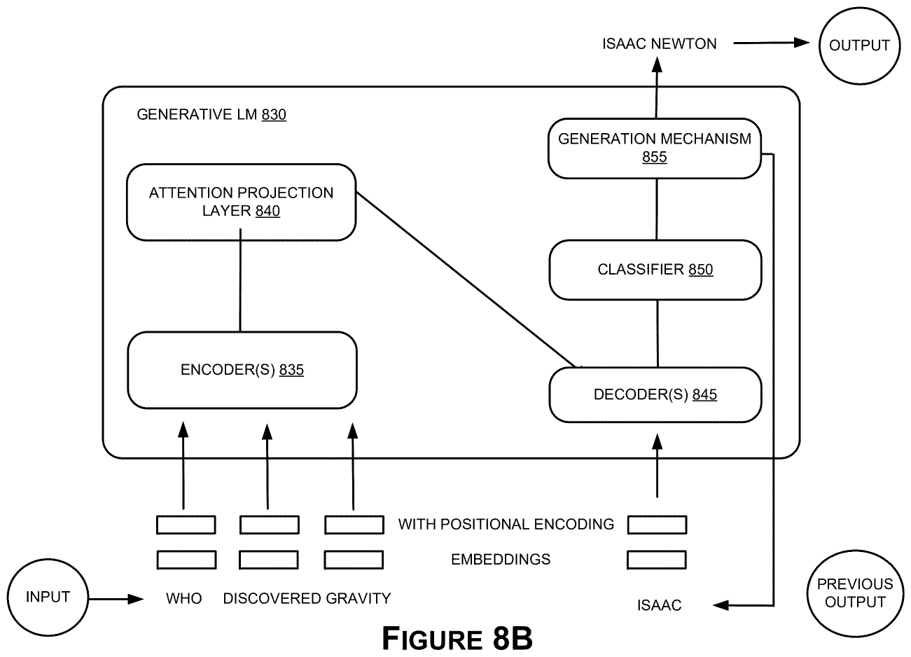

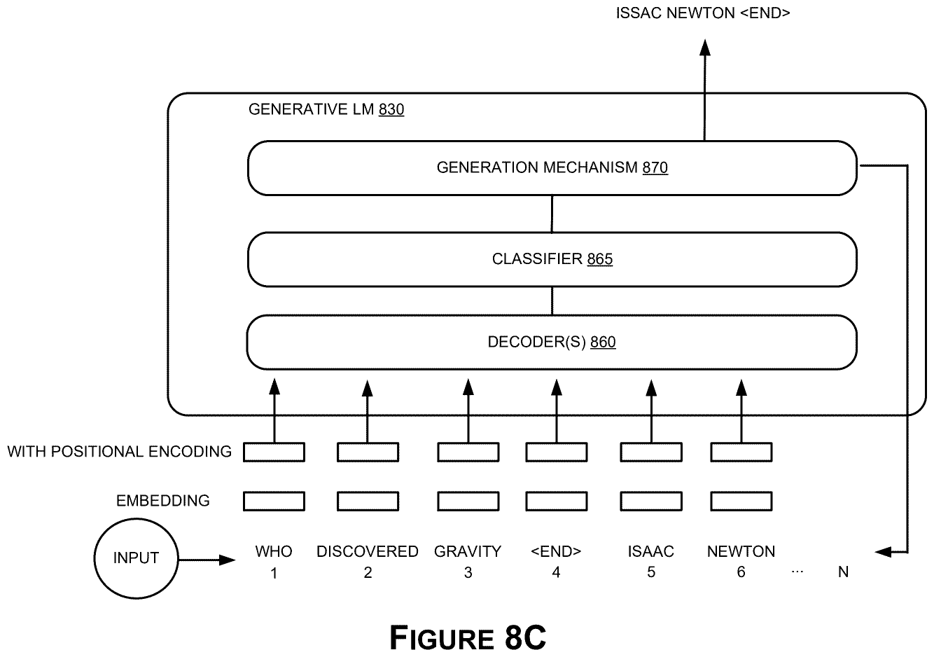

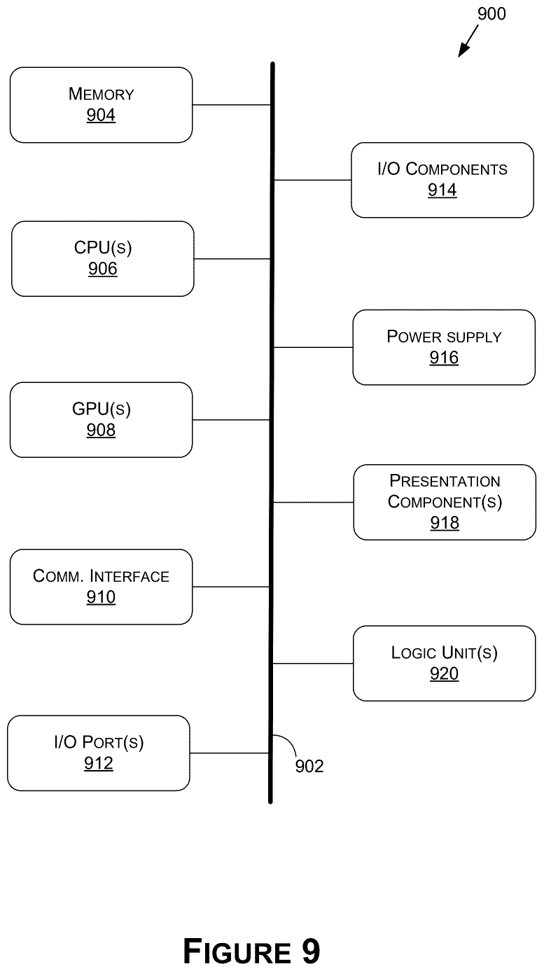

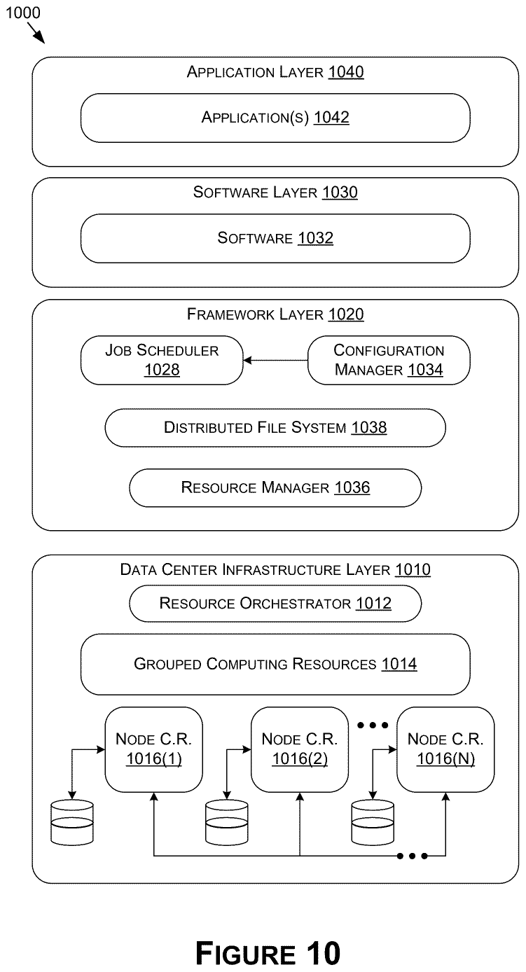

With reference to FIG. 1, FIG. 1 is a system-level block diagram showing an example of a generalized pipeline associated with an expert-aware RAG system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 8A-8C), one or more computing devices or components thereof (e.g., as described in FIG. 9), and/or one or more data centers or components thereof (e.g., as described in FIG. 10).

As shown in the example of FIG. 1, the expert-aware RAG system 100 may include, amongst additional or alternative components, an ingestion component 102, an enrichment component 104, one or more databases 106, a retrieval component 108, and an agentic RAG system 110. In some examples, the ingestion component 102 may obtain raw or unstructured content from a variety of sources, such as internal organizational documents, public articles, transcripts, technical reports, emails, or other forms of text, image, or audio data. In some embodiments, the ingestion component 102 may also parse and preprocess the content to identify structural elements (e.g., sections, bullet points, tables), semantic boundaries, or template-based patterns for downstream processing.

The enrichment component 104 may receive the parsed or chunked content and associate one or more metadata fields with each content portion. This metadata may include author identifiers, roles, areas of expertise, organizational affiliations, dates, topics, or relationships to specific customers or projects. In some examples, the enrichment process may also involve referencing or generating an author-entity or contributor-topic graph, which captures connections between content sources and relevant domains of knowledge. This enriched representation may support expert-aware filtering and reranking during retrieval.

The database(s) 106 may store the enriched content in formats optimized for keyword and/or semantic retrieval. For instance, the system may store vector embeddings for each chunk to support similarity-based search, while also maintaining inverted indices or other structures for efficient keyword-based querying. Metadata fields may be indexed as well, enabling attribute-based filtering or retrieval by expert relevance, document type, or other contextual factors.

The retrieval component 108 may process incoming queries and retrieve relevant content using keyword-based, semantic, or hybrid techniques. The retrieval results may be filtered, scored, or reranked based on expert metadata and graph-based relationships to prioritize content that is more likely to reflect credible, context-aware, or experience-based information. In some examples, threshold-based logic or diversity filtering may be applied to limit redundancy and reduce computational overhead for downstream processing.

The agentic RAG system 110 may coordinate additional steps such as dynamic summarization, recursive condensation of retrieved content, and the generation of a final response using one or more generative language models. The agentic RAG system 110 may also implement query-aware logic to customize summarization or reranking behavior based on the user's intent. In some cases, the agentic RAG system 110 may include optional feedback loops, evaluation modules, or user-facing interfaces to support refinement, review, or interaction with the generated responses.

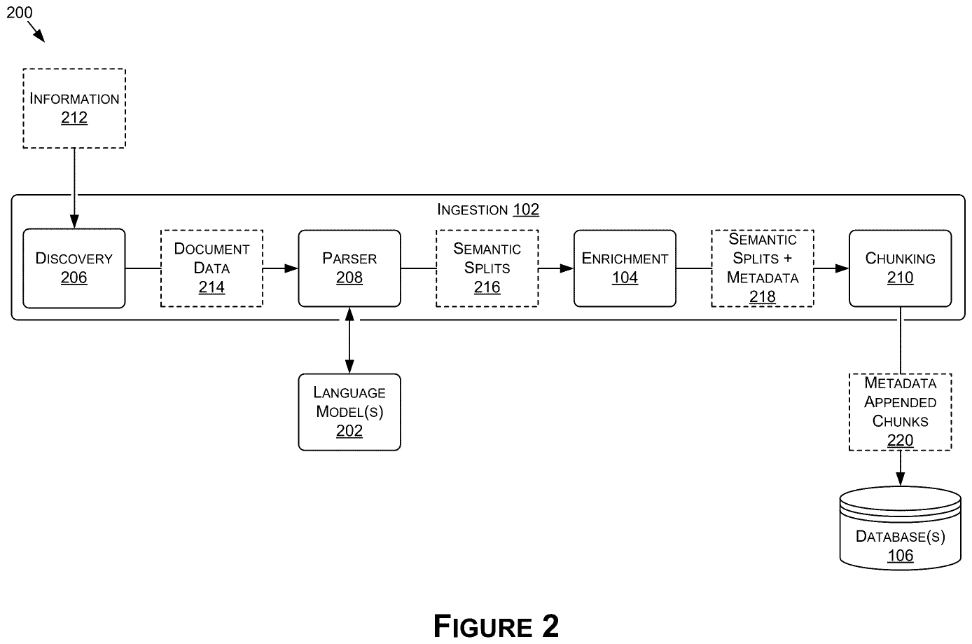

While FIG. 1 presents a high-level overview of the expert-aware RAG system 100 and its major components, FIG. 2 illustrates additional detail specific to the ingestion and enrichment stages of the pipeline. In particular, FIG. 2 is a data flow diagram illustrating an example ingestion and enrichment process 200 that may be performed by the expert-aware RAG system 100, in accordance with some embodiments of the present disclosure.

As shown, the ingestion and enrichment process 200 may be implemented using, amongst additional alternative components, the ingestion component 102, the enrichment component 104, the database(s) 106, and one or more language models 202. Additionally, the ingestion component 102 may include a discovery component 206, a parser 208, and a chunking component 210 that may implement one or more aspects of the process 200. As a brief overview of the ingestion and enrichment process 200, the discovery component 206 may obtain information 212, which may include documents, reports, transcripts, websites, organizational structure data, or any other text, audio, or image-based sources. This content may originate from local systems, enterprise tools, public web repositories, or other external or internal sources. The discovery component 206 may transform the acquired information 212 into document data 214, which may include extracted raw content along with any associated metadata (e.g., file origin, timestamps, or detected source characteristics). The document data 214 may be passed to the parser 208, which may use one or more language models 202 to identify semantic structure in the content, such as sections, paragraphs, bullets, tables, or narrative shifts. Based on this analysis, the parser 208 may output semantic splits 216 that divide the original content into logically meaningful portions. The enrichment component 104 may then analyze the semantic splits to generate or attach metadata related to authorship, expertise, organizational affiliation, or topical relevance-potentially leveraging contributor graphs or pretrained entity recognition models. This enriched output is shown as semantic splits+metadata 218. The chunking component 210 may then format and package the enriched portions into metadata-appended chunks 220, suitable for downstream storage and retrieval. The metadata-appended chunks 220 may then be stored in the database(s) 106 using indexing structures and formats that support both semantic and keyword-based search.

In various embodiments, the discovery component 206 may serve as the entry point for new or updated content flowing into the expert-aware RAG system 100. The discovery component 206 may be configured to continuously or periodically scan, crawl, or otherwise access one or more data sources—such as document repositories, knowledge bases, shared drives, content management systems, email servers, public websites, or other content pipelines—to obtain new information 212. In some examples, the discovery process may involve authenticating with protected data sources, applying inclusion or exclusion rules, or filtering out files based on format, content type, or predefined metadata. The information 212 may include any combination of structured or unstructured content, such as PDFs, Word documents, HTML pages, Markdown files, transcripts, spreadsheets, organizational charts, or JSON payloads.

In some embodiments, the discovery component 206 may also identify or extract elements of organizational structure from the content itself. For instance, internal documents—such as trip reports, meeting summaries, or engagement updates—may follow known or semi-structured templates that include labeled sections for customer interactions, technical feedback, lessons learned, or next steps. The discovery component 206 may surface or preserve this structure to support more effective parsing and semantic interpretation downstream. As one example, a standardized report may include a subject line that names a customer, region, and technology area, with body content organized into predictable sections authored by various stakeholders (e.g., engineers, program managers, field personnel). This structural information may be retained or passed along as part of the document data 214.

The discovery component 206 may generate and output the document data 214, which may represent a normalized, extracted, or intermediate version of the source content. This output may include raw text and/or associated contextual signals that may be used in subsequent parsing or enrichment steps. In some examples, the discovery component 206 may also record or tag contextual metadata such as the author's name, organizational affiliation, project involvement, or document source. This metadata—when combined with extracted structural cues—may support later identification of credible or expert-aligned authors and may be used in the construction of author-entity graphs or domain-specific relevance signals for retrieval and reranking.

The parser 208 may be configured to process the document data 214 and extract structural, semantic, or context-aware elements from the content. In some examples, the parser 208 may identify natural or templated breakpoints within a document—such as section headers, bullet lists, tables, or delineated narrative segments—and use these to produce semantically meaningful portions. These portions may preserve the logical boundaries and intent of the source material. For example, if the document data 214 corresponds to a field report with labeled sections for “Customer Feedback,” “Action Items,” and “Deployment Issues,” the parser 208 may detect these sections and segment them accordingly.

In some embodiments, the parser 208 may leverage the language model(s) 202 to assist in identifying semantic structure, disambiguating contextual references, or recognizing domain-specific terminology. For instance, the language model(s) 202 may be used to infer implicit section boundaries in freeform narrative text, detect repeated patterns across similarly formatted reports, or resolve acronyms and named entities. In certain cases, template-aware logic may be applied to known document types—such as standardized trip reports or internal engineering logs—where the parser 208 may recognize recurring field labels or patterns and extract structured information accordingly (e.g., dates, project codes, customer names, named authors, or referenced systems).

The parser 208 may output one or more semantically segmented portions, referred to in FIG. 2 as semantic splits 216. These semantic splits 216 may serve as the basis for subsequent enrichment steps and may be packaged together with intermediate metadata and structure-preserving cues to maintain fidelity to the original source material.

The enrichment component 104 may receive the semantic splits 216 from the parser 208 and associate them with one or more metadata fields. The metadata fields may describe contextual, structural, or organizational information related to the content portion, including—but not limited to—author identity, role or title, domain expertise, document source, publication date, referenced customers, associated projects, geographic regions, or technology areas. In some examples, the enrichment component 104 may use information carried forward from the ingestion or parsing stages (e.g., extracted field labels, surrounding text context, embedded references) to populate these metadata fields.

In some embodiments, the enrichment component 104 may also reference external sources—such as organizational charts, project databases, or manually curated knowledge bases—to validate or expand metadata fields. For example, the enrichment component 104 may map a named author to a known team within the organization, determine their role at the time of authorship, or infer their connection to specific deployments. This metadata may later support expert-aware reranking or graph-based prioritization during retrieval.

Additionally, or alternatively, the enrichment process may include the construction or updating of an author-entity or contributor-topic relationship graph. This graph may model the associations between individual content contributors and the entities, customers, domains, or projects they are known to interact with. For example, the system may create specialized retriever collections that explicitly establish and store relationships between customer names (or account identifiers) and specific industry experts. This allows the system to encode domain expertise and direct customer experience at the data level. For example, if several reports authored by the same engineer consistently reference specific product lines or client deployments, the enrichment component 104 may strengthen the graph connections between that engineer and those topics. These connections may, in turn, be used to identify authoritative sources during retrieval or reranking.

The chunking component 210 may receive enriched and segmented content (e.g., semantic splits+metadata 218) from the enrichment component 104 and may further process the content into finalized, metadata-appended units for storage. In some examples, the chunking component 210 may apply context-aware logic to balance semantic coherence with retrieval efficiency, producing chunks that are neither too short to lack context nor too long to exceed model input limits. These final chunks—referred to as metadata-appended chunks 220—may preserve the enriched metadata (e.g., author role, project affiliation, topic labels) while aligning with meaningful content boundaries.

In certain embodiments, the chunking component 210 may consider previously computed semantic splits 216 and make adjustments based on updated enrichment context, structural cues, or downstream storage and indexing requirements. This may include merging or subdividing segments, tagging positional context (e.g., section index or paragraph order), or formatting the chunks into a standardized schema for compatibility with vector databases or keyword-based indices. Once generated, the metadata-appended chunks 220 may be forwarded to the database(s) 106 for storage, enabling later retrieval based on semantic similarity, keyword overlap, or expert-aware metadata filtering.

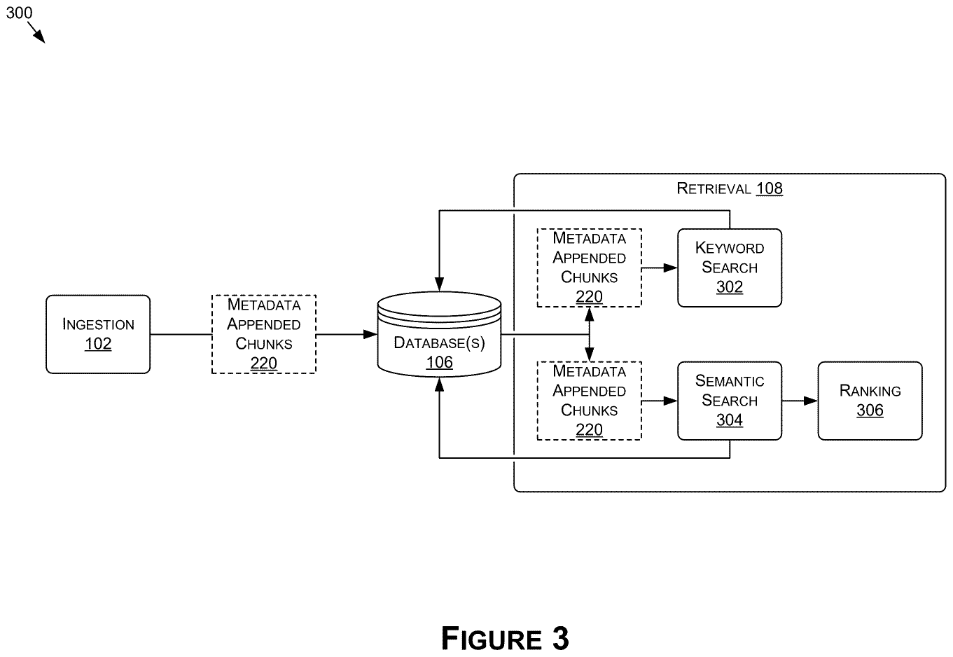

Now turning to FIG. 3, FIG. 3 is a data flow diagram illustrating an example retrieval process 300 using keyword and semantic search over metadata-enriched document chunks, in accordance with some embodiments of the present disclosure. As shown, the retrieval process 300 may begin with metadata-appended chunks 220 stored in the database(s) 106, which may be output by the ingestion component 102. The retrieval component 108 may include a keyword search component 302, a semantic search component 304, and a ranking component 306, which may access the stored metadata-appended chunks 220 to identify potentially relevant content.

In some examples, the system may implement a hybrid retrieval strategy, leveraging both keyword-based matching and semantic similarity scoring to improve recall and precision. For instance, the keyword search component 302 may be used to capture exact term matches or structured field queries, while the semantic search component 304 may—in parallel—use vector embeddings to identify conceptually related content even in the absence of matching keywords. The results from both may be merged and passed to the ranking component 306, which may re-rank the document portions based on metadata signals, author credibility, topic relevance, or graph-based relationships.

In some embodiments, the retrieval component 108 may implement a threshold-based retrieval optimization technique to balance comprehensiveness with computational efficiency. For example, the retrieval component 108 may retrieve and order document chunks by relevance score (e.g., cosine similarity or distance in embedding space), and apply a configurable threshold to determine when to stop including additional content. If the similarity scores fall below this threshold, the retrieval component 108 may dynamically halt retrieval, thus preventing the inclusion of irrelevant information while reducing the number of downstream summary operations. In some implementations, this may be enabled by paginated search capabilities of vector databases (e.g., Milvus), allowing flexible tuning of result depth based on query complexity or user intent. This hybrid, threshold-aware retrieval approach may improve performance and user experience by surfacing high-quality, context-rich information while maintaining low latency and manageable compute cost.

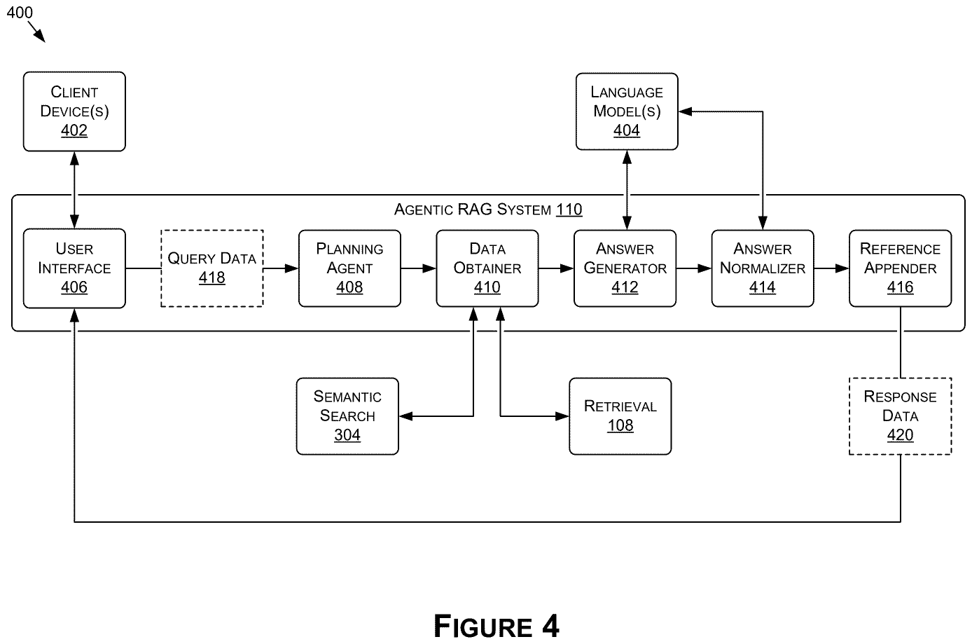

Referring now to FIG. 4, FIG. 4 is a data flow diagram illustrating an example process 400 that may be performed by the agentic RAG system to generate a response to a user query, in accordance with some embodiments of the present disclosure. As shown, the agentic RAG system 110 may include a user interface 406 through which a query may be received from one or more client devices 402. Query data 418 representing the query may then be passed to a planning agent 408, which may be responsible for determining how best to handle the query such as identifying relevant tools or content scopes to invoke.

In some embodiments, the planning agent 408 may initiate the data obtainer 410, which may access or call the retrieval component 108 and/or the semantic search component 304 to retrieve relevant content, such as metadata-appended chunks 220 of previously ingested and enriched content. These chunks may be selected and filtered based on query context, expert relevance, or graph-based prioritization.

Once the appropriate content has been retrieved, the agentic RAG system 110 may invoke an answer generator 412 to synthesize a response using one or more language models 404, which may be the same as or different from the language model(s) 202. In some embodiments, the answer generator 412 may operate using specialized summarization techniques such as map-reduce summarization, in which long sets of documents may be split into context-window-sized batches, summarized in parallel, and recursively combined to form a comprehensive response. Additionally, the answer generator 412 may incorporate expert content prioritization techniques-leveraging metadata and graph-based author-topic relationships to amplify the influence of authoritative sources during summarization.

In addition, the answer generator 412 may support dynamic summarization using query-specific prompts. Rather than relying on static instructions, the answer generator 412 may adapt the prompt or summarization strategy based on the intent, domain, or phrasing of the user query, allowing it to preserve domain-specific terminology, customer-relevant details, and contextual nuance. This dynamic summarization prompt may include query-specific details to guide the model to retain information likely relevant to the specific query type, thereby mitigating the loss of critical details often associated with static map-reduce summarization. This dynamic behavior may improve response quality for specialized or technical queries by retaining details that would otherwise be lost in generic summarization. In some examples, these prompts may incorporate structured query understanding, leveraging graph-based query analysis or context-aware filters derived from the planning agent 408.

The resulting draft answer may then be refined by an answer normalizer 414, which may ensure consistency, completeness, or adherence to desired formatting conventions. A reference appender 416 may follow, responsible for attaching citations, source links, or metadata pointers to support in-line verification or attribution. In some cases, the agentic RAG system 110 may apply graph-based reranking or expert filtering during citation selection, using author-entity relationship graphs or domain-linked metadata to ensure that the most authoritative and contextually aligned sources are surfaced. This graph-based awareness may extend beyond citation into the full response generation process, allowing the system to emphasize insights that reflect firsthand domain knowledge.

The final response data 420 may be returned to the client device 402 via the user interface 406. In some implementations, the agentic RAG system 110 may support advanced capabilities such as query decomposition, parallel tool invocation, or context-aware conference detection—for instance, automatically identifying which internal conference a query references and selecting the appropriate retriever collection without explicit user input. The system may be implemented using a LangGraph-based orchestration framework, in which the agent workflow follows a directed graph of tools, enabling flexible routing, conditional branching, and modular execution. This architecture may support both simple and complex queries, enabling the system to synthesize answers across diverse data sources while remaining scalable and platform-agnostic.

In some instances, the agentic RAG system 110 may also maintain short-term conversational memory across multiple user turns. For instance, when a user issues a follow-up query, the system may infer the relevant conference or domain context from previous interactions—automatically reapplying the last referenced collection without requiring explicit user input. This context-carryover mechanism may support more natural, multi-turn conversations while detecting when users shift topics or reference different data scopes.

Additionally, a caching mechanism may be integrated into the agentic RAG system 110 to improve responsiveness for common or computationally intensive queries. In some embodiments, answers to frequent queries may be precomputed and stored—either as final responses or as intermediate retrieval results-bypassing the need for repeated processing. The caching system may implement selective invalidation strategies to refresh outdated answers when new documents are ingested, thus balancing performance with data freshness.

To further enhance the user experience, the agentic RAG system 110 may include a suggestive question component (not shown) that may be configured to dynamically generate relevant follow-up queries based on the current interaction. This component may operate using a two-tier approach: general-purpose baseline questions applicable across conferences, and context-specific prompts tailored to the user's most recent query or retrieved content. These suggested questions may be presented via the user interface as clickable options, helping users discover comparative insights or refine their exploration paths—regardless of technical background.

In some embodiments, the ingestion and agentic RAG components may be deployed within containerized infrastructure managed by an orchestration platform such as Kubernetes. The ingestion service may be configured as a singleton pod with liveness and readiness probes that support automatic health monitoring. If failures are detected—such as a node crash or service stall—the orchestration layer may automatically restart the service on a healthy node. To ensure ingestion continuity, the pipeline may implement transactional checkpoints that track progress at the chunk level, allowing interrupted operations to resume without data loss or duplication.

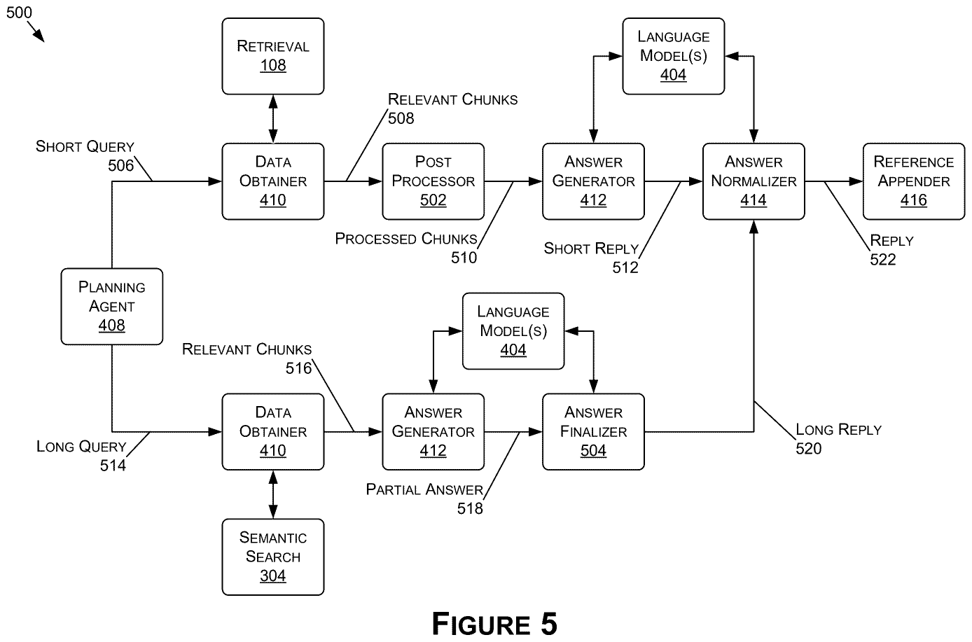

Now turning to FIG. 5, FIG. 5 is a data flow diagram illustrating an example branching flow 500 for handling different types of user queries within the agentic RAG system, in accordance with some embodiments of the present disclosure. As shown, the branching flow 500 may support different processing paths depending on query complexity, content length, or system-determined classification.

For instance, the process may begin with a user query received by the agentic RAG system 110 via the planning agent 408. The planning agent 408 may analyze the query to determine its length, structure, or intent, and may decide whether the query should be treated as a short query 506 or long query 514. For instance, a short query 506 may correspond to requests that can be answered with minimal context, while a long query 514 may require deep retrieval, summarization, or multi-stage synthesis across multiple documents or topics.

For short queries 506, the planning agent 408 may direct the query to the data obtainer 410, which may access the retrieval component 108 to obtain relevant chunks 508 (e.g., via ranked hybrid retrieval process described herein). In some implementations, these chunks may be passed to a post processor 502 that may apply lightweight formatting, content filtering, or pre-summarization heuristics, resulting in processed chunks 510. These processed chunks may then be passed to the answer generator 412, which may use one or more language models 404 to synthesize a concise response, referred to as a short reply 512 (e.g., short context reply). The short reply 512 may be normalized into a reply 522 by the answer normalizer 414—ensuring structural consistency, tone alignment, and formatting—and then forwarded to the reference appender 416 to generate the final output of the reply 522.

In contrast, for long queries 514, the planning agent 408 may trigger a deeper semantic analysis workflow. The data obtainer 410 may be invoked to perform a semantic search via the semantic search component 304 and retrieve broader or more conceptually aligned content, resulting in a set of relevant chunks 516 (e.g., a large number of relevant chunks). These chunks may be passed to the answer generator 412 for initial synthesis. In some cases, due to length or complexity, the answer generator 412 may produce a plurality of partial answers and iteratively summarize or distill these into a single partial answer 518. The partial answer 518 may then be passed to an answer finalizer 504, which may use the language model(s) 404 to recursively refine, combine, or restructure the partial output. This step may implement techniques such as map-reduce summarization, recursive distillation, or query-specific prompt expansion to ensure that the final long reply 520 (e.g., long context reply) remains accurate, comprehensive, and coherent. As with the short path, the long reply 520 may be normalized by the answer normalizer 414 to generate the reply 522 and then passed to the reference appender 416 to generate the final output.

In some embodiments, the post processor 502 and the answer finalizer 504 may include specialized logic depending on the nature of the query. For example, the post processor 502 may compress repetitive structures or apply filtering rules based on document confidence scores, while the answer finalizer 504 may operate with memory of earlier synthesis steps, support query decomposition, or re-rank intermediate results prior to final answer assembly.

The branching architecture illustrated in the example of FIG. 5 may enable the agentic RAG system 110 to adaptively handle both lightweight and complex requests-balancing computational efficiency with response quality. By tailoring the generation pipeline to the nature of each query, the system may reduce latency for simple requests while still offering depth and robustness for more nuanced information needs.

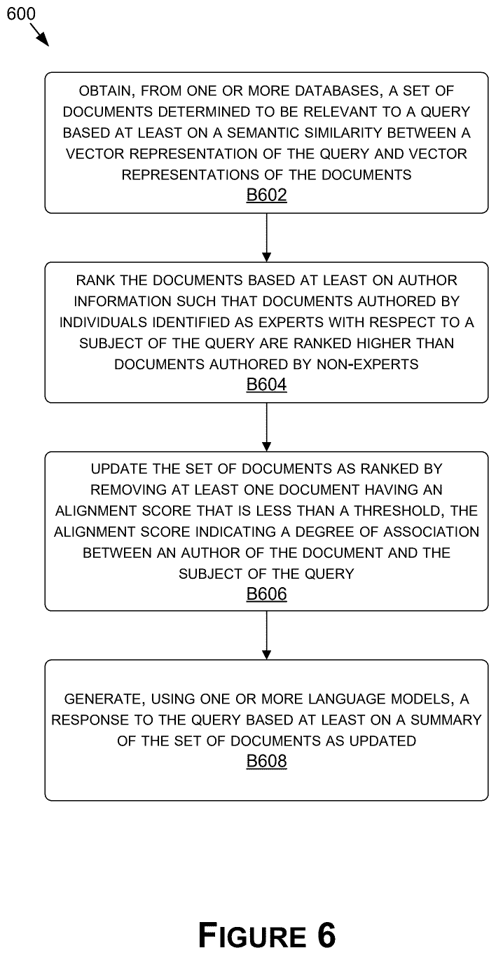

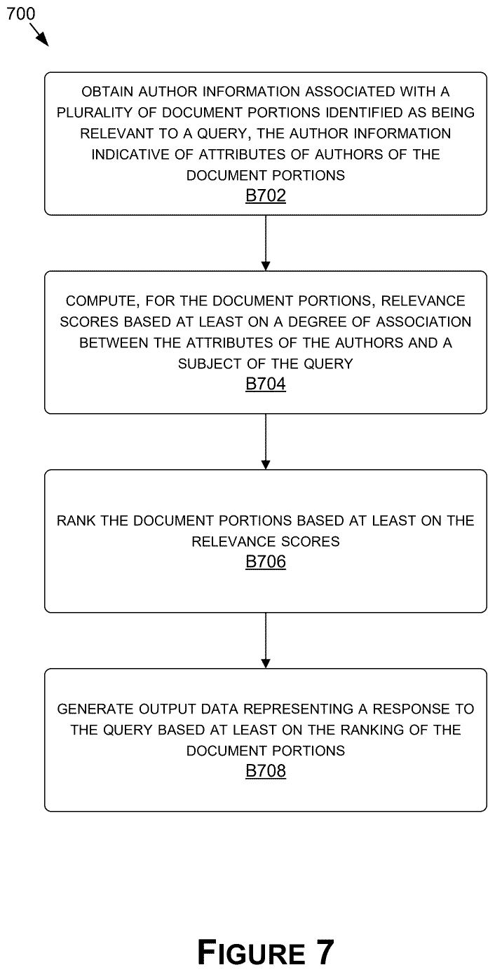

Now referring to FIGS. 6 and 7, each block of methods 600 and 700, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 600 and 700 are described, by way of example, with respect to the system of FIGS. 1-5. However, these methods may additionally or alternatively be executed by any one system, or any combination of systems, including, but not limited to, those described herein.

FIG. 6 is a flow diagram illustrating an example of a method 600 for expert-aware content enrichment, retrieval, and response generation, in accordance with some embodiments of the present disclosure. The method 600, at block B602, may include obtaining, from one or more databases, a set of documents determined to be relevant to a query based at least on a semantic similarity between a vector representation of the query and vector representations of the documents. For instance, the retrieval component 108 may obtain the set of documents from the database(s) 106. In some examples, the keyword search component 302 and/or the semantic search component 304 may determine the documents to be relevant to the query. In particular, the semantic search component 304, in some examples, may determine the documents to be relevant to the query based at least on a semantic similarity between a vector representation of the query and vector representations of the documents.

The method 600, at block B604, may include ranking the documents based at least on author information such that documents authored by individuals identified as experts with respect to a subject of the query are ranked higher than documents authored by non-experts. For example, the ranking component 306 of the retrieval component 108 may rank the documents (e.g., the metadata appended chunks 220) based at least on the author information such that the documents authored by the individual identified as experts with respect to the subject of the query are ranked higher than the documents authored by non-experts. In some examples, this author expertise may be determined through contributor-topic graphs or historical document analysis that encodes domain-specific authorship trends. The ranking process may also weight recency or document type when assessing author relevance, prioritizing recent field reports or conference submissions over older, generic sources.

The method 600, at block B606, may include updating the set of documents as ranked by removing at least one document having an alignment score that is less than a threshold, the alignment score indicating a degree of association between an author of the document and the subject of the query. For instance, the ranking component 306 may update the ranked set of documents by removing at least one (e.g., one or more) document having the alignment score that is less than the threshold. In some instances, the alignment score may indicate the degree of association between the author of the document in the subject of the query. That is, the alignment score may be computed using a weighted function that considers the frequency and specificity of topic mentions, co-occurrence in customer-facing documents, or proximity within organizational graphs. In some examples, the score may be dynamically adjusted based on the context of the query, such that expertise in adjacent domains may still yield moderately high alignment for interdisciplinary queries.

In some instances, the alignment score may be computed based on one or more features that indicate the degree of association between an author and the subject of the query. For example, the alignment score may incorporate: a proximity score in an author-subject graph, where nodes represent authors and subject entities (e.g., technology areas, customers, events), and edges represent relationships such as document authorship, co-authorship, subject tagging, or citation links; one or more expertise labels (e.g., tagged domains, technologies, customers) associated with the author, which may be derived from structured metadata extracted during ingestion; a frequency or recency score, indicating how often or how recently the author has contributed relevant content tied to the subject; and/or historical document relevance scores, computed from prior retrieval or summarization interactions involving the author's documents. These signals may be normalized and combined using a weighted scoring function to generate the alignment score. The threshold used for document filtering may be statically defined or dynamically computed (e.g., using a percentile-based cutoff on the distribution of alignment scores for a given query).

The method 600, at block B608, may include generating, using one or more language models, a response to the query based at least on a summary of the set of documents as updated. For example, the agentic RAG system 110 may use the language model(s) 404 to generate the response to the query based at least on the summary of the set of documents as updated. In some embodiments, the summary may be generated using map-reduce techniques and may incorporate query-specific prompt engineering to preserve terminology, customer identifiers, and nuanced contextual elements. The system(s) may optionally apply answer normalization, source citation, or expert annotation overlays to ensure traceability and enhance user trust in the generated output.

FIG. 7 is a flow diagram illustrating an example of a method 700 for generating query responses using author-aware relevance scoring, in accordance with some embodiments of the present disclosure. The method 700, at block B702, may include obtaining author information associated with a plurality of document portions identified as being relevant to a query, the author information indicative of attributes of authors of the document portions. In some examples, the author information may be extracted or inferred during earlier enrichment stages (e.g., by the enrichment component 104 or ranking component 306) and may include details such as the author's organizational role, domain expertise, project participation, historical contributions, or prior association with the entities or topics mentioned in the query. This information may be retrieved from metadata appended to content chunks or from an external author-entity graph stored within the database(s) 106.

The method 700, at block B704, may include computing, for the document portions, relevance scores based at least on a degree of association between the attributes of the authors and a subject of the query. For example, the ranking component 306 may generate an author-aware relevance score that combines multiple weighted factors-such as topical overlap, co-authorship frequency with recognized experts, recency of publication, and customer or project alignment. In some embodiments, the scores may be dynamically adjusted using graph-based traversal techniques, where proximity between an author node and a domain or customer node within a contributor-topic graph increases the author's influence on the scoring outcome. The retrieval component 108 may further apply context-sensitive scaling to emphasize subject matter expertise when queries explicitly reference technical or specialized domains.

In some examples, the subject of the query may include one or more topics, entities, or contextual dimensions inferred from the input query. These may include, but are not limited to, technology domains (e.g., AI acceleration, networking, simulation), customer names or accounts, conferences, events, or engagement contexts, regions, business units, or organizational groups, specific product names, tools, and/or feature areas. The subject of the query may be inferred explicitly (e.g., named in the query string) or implicitly (e.g., using a query classification model or subject extractor). The subject may also be cross-referenced with metadata tagged to documents, such as customer tags, conference labels, document section headers, or extracted entities. This information may be used both in document selection and in determining alignment with author metadata.

The method 700, at block B706, may include ranking the document portions based at least on the relevance scores. For instance, document portions associated with highly aligned or domain-credible authors may be ranked higher than those with weaker or indirect associations. In some examples, the ranking process may also incorporate secondary features such as content quality, metadata completeness, or contextual diversity to ensure that the resulting ranked set includes both highly authoritative and contextually broad perspectives. In some embodiments, threshold-based ranking refinement may be applied to remove document portions with scores below a configurable cutoff, improving precision and efficiency in downstream summarization and response generation.

The method 700, at block B708, may include generating output data representing a response to the query based at least on the ranking of the document portions. For example, the agentic RAG system 110 may invoke the language model(s) 404 to synthesize a final response that prioritizes insights, summaries, or excerpts from top-ranked document portions. In some instances, the response generation may further incorporate citation or attribution logic—linking each referenced statement to its corresponding author and document source—to improve interpretability. The generated response may thus reflect not only the semantic relevance of the underlying content but also the credibility and domain expertise of its original contributors.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process maybe repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 8A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-1016(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Example Clauses

Clause 1. A method comprising: obtaining, from one or more databases at least partially responsive to receiving input data representing a query related to a subject, a set of documents determined to be relevant to the query based at least on a semantic similarity between a vector representation of the query and vector representations of the documents; ranking the documents based at least on author information stored in association with the documents such that documents authored by individuals identified as experts with respect to the subject of the query are ranked higher than documents authored by non-experts; updating the set of documents as ranked by removing at least one document having an alignment score that is less than a threshold, the alignment score indicating a degree of association between an author of the document and the subject of the query; and generating, using one or more language models, a response to the query based at least on a summary of the set of documents as updated.

Clause 2. The method of clause 1, wherein the author information includes at least expertise labels associated with authors of the documents, and wherein the ranking of the documents comprises assigning higher alignment scores to documents having expertise labels that correspond to the subject of the query.

Clause 3. The method of clause 1, further comprising: assigning numerical weights to authors of the documents based at least on a level of expertise of the authors with respect to the subject, wherein the ranking of the documents comprises applying a scoring function that combines a semantic similarity between the query and the documents with the numerical weights assigned to the authors of the documents.

Clause 4. The method of clause 1, wherein the author information is indicative of subject-specific expertise associated with authors of the documents, the author information derived from at least one of structured metadata or a graph data structure indicating relationships between the authors and subjects.

Clause 5. The method of clause 4, wherein: the ranking of the documents is further based at least on whether the authors of the documents are identified as experts with respect to the subject of the query, and the updating of the set of documents is based at least on the ranking such that documents written by identified experts are more likely to be retained than documents written by others.

Clause 6. The method of clause 1, further comprising: computing the threshold based at least on a distribution of alignment scores for the documents, the alignment scores indicating the degree of association between the authors of the documents and the subject of the query; and comparing the alignment scores of the documents with the threshold, wherein the removing of the at least one document is based at least on the comparing.

Clause 7. The method of clause 1, further comprising: grouping the set of documents as updated into two or more groups based at least on information indicating at least one of: a context of the documents; a source of the documents; an event associated with the documents; or an entity associated with the documents. generating two or more intermediate summaries corresponding to the two or more groups; and generating the summary of the set of documents based at least on combining the two or more intermediate summaries.

Clause 8. The method of clause 1, further comprising generating the summary of the set of documents using one or more second language models based at least on applying, as an input prompt to the one or more second language models, information derived from the query and determined to be relevant to the query.

Clause 9. A system comprising one or more processors to: obtain author information associated with a plurality of document portions identified as being relevant to a query, the author information indicative of attributes of authors of the document portions; compute, for the document portions, relevance scores based at least on a degree of association between the attributes of the authors and a subject of the query; rank the document portions based at least on the relevance scores; and generate output data representing a response to the query based at least on the ranking of the document portions.

Clause 10. The system of clause 9, wherein the relevance scores are computed using a scoring function that combines: a similarity score computed based at least on a comparison between a vector representation of the query and vector representations of the document portions; and an alignment score computed based at least on the degree of association between the attributes of the authors and the subject of the query.

Clause 11. The system of clause 9, the one or more processors further to: compute a vector representation of the query and vector representations of the document portions; determine semantic similarities between the query and the document portions based at least on a comparison of the vector representations; and identify the plurality of document portions as being relevant to the query based at least on a determination that the semantic similarities between the query and the document portions meet or exceed a threshold.

Clause 12. The system of clause 9, the one or more processors further to compute, for the document portions, the relevance scores based at least on a graph data structure indicating relationships between the authors and a plurality of subjects.

Clause 13. The system of clause 9, wherein the ranking of the document portions comprises: identifying one or more document portions having one or more scores that are less than a threshold; and based at least on the one or more scores being less than the threshold, excluding the one or more document portions from being used to generate the response.

Clause 14. The system of clause 9, the one or more processors further to: generate a first intermediate summary of a first subset of the document portions as ranked; generate a second intermediate summary of a second subset of the document portions as ranked; and generate, based at least on a combination of the first intermediate summary and the second intermediate summary, a final summary of the document portions, wherein the output data is generated using the final summary of the document portions.

Clause 15. The system of clause 14, further comprising: grouping the first subset of the document portions as ranked such that the first subset includes one or more first document portions associated with at least one of a first subject or a first entity; and grouping the second subset of the document portions as ranked such that the second subset includes one or more second document portions associated with at least one of a second subject or a second entity.

Clause 16. The system of clause 9, wherein the generation of the output data comprises: applying a prompt to a language model, the prompt including the query and a summary of the document portions; and generating, using the language model and based at least on the prompt, the output data representing the response.

Clause 17. The system of clause 9, wherein the attributes of the authors include at least one of: area of expertise; expertise level, subject association, organizational position, historical performance metrics, or professional background information.

Clause 18. The system of clause 9, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system that incorporates one or more machine learning models deployed in a service or microservice along with an OS-level virtualization package; a system implemented at least partially in a data center; or a system implemented at least partially using cloud computing resources.

Clause 19. One or more processors comprising processing circuitry to: store, in one or more data repositories, portions of documents in association with author information that is indicative of subject-specific expertise of authors of the portions of the documents, wherein the portions of the documents are indexed or grouped based at least on a relationship between an author of a specific portion of a document and one or more subjects associated with content included in the specific portion of the document.

Clause 20. The one or more processors of clause 19, the processing circuitry further to: obtain, based at least on a determination that one or more portions of the documents are relevant to a query, the portions of the documents and the associated author information stored in the one or more data repositories; compute, for the obtained portions of the documents, respective relevance scores based at least on a degree of association between attributes of the authors and a subject of the query; rank the portions of the documents based at least on the relevance scores; and generate output data representing a response to the query based at least on the ranking of the portions of the documents.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
obtaining, from one or more databases at least partially responsive to receiving input data representing a query related to a subject, a set of documents determined to be relevant to the query based at least on a semantic similarity between a vector representation of the query and vector representations of the documents;
ranking the documents based at least on author information stored in association with the documents such that documents authored by individuals identified as experts with respect to the subject of the query are ranked higher than documents authored by non-experts;
updating the set of documents as ranked by removing at least one document having an alignment score that is less than a threshold, the alignment score indicating a degree of association between an author of the document and the subject of the query; and
generating, using one or more language models, a response to the query based at least on a summary of the set of documents as updated.

2. The method of claim 1, wherein the author information includes at least expertise labels associated with authors of the documents, and wherein the ranking of the documents comprises assigning higher alignment scores to documents having expertise labels that correspond to the subject of the query.

3. The method of claim 1, further comprising:
assigning numerical weights to authors of the documents based at least on a level of expertise of the authors with respect to the subject,
wherein the ranking of the documents comprises applying a scoring function that combines a semantic similarity between the query and the documents with the numerical weights assigned to the authors of the documents.

4. The method of claim 1, wherein the author information is indicative of subject-specific expertise associated with authors of the documents, the author information derived from at least one of structured metadata or a graph data structure indicating relationships between the authors and subjects.

5. The method of claim 4, wherein:
the ranking of the documents is further based at least on whether the authors of the documents are identified as experts with respect to the subject of the query, and
the updating of the set of documents is based at least on the ranking such that documents written by identified experts are more likely to be retained than documents written by others.

6. The method of claim 1, further comprising:
computing the threshold based at least on a distribution of alignment scores for the documents, the alignment scores indicating the degree of association between the authors of the documents and the subject of the query; and
comparing the alignment scores of the documents with the threshold,
wherein the removing of the at least one document is based at least on the comparing.

7. The method of claim 1, further comprising:
grouping the set of documents as updated into two or more groups based at least on information indicating at least one of:
a context of the documents;
a source of the documents;
an event associated with the documents; or
an entity associated with the documents;
generating two or more intermediate summaries corresponding to the two or more groups; and
generating the summary of the set of documents based at least on combining the two or more intermediate summaries.

8. The method of claim 1, further comprising generating the summary of the set of documents using one or more second language models based at least on applying, as an input prompt to the one or more second language models, information derived from the query and determined to be relevant to the query.

9. A system comprising one or more processors to:
obtain author information associated with a plurality of document portions identified as being relevant to a query, the author information indicative of attributes of authors of the document portions;
compute, for the document portions, relevance scores based at least on a degree of association between the attributes of the authors and a subject of the query;
rank the document portions based at least on the relevance scores; and
generate output data representing a response to the query based at least on the ranking of the document portions.

10. The system of claim 9, wherein the relevance scores are computed using a scoring function that combines:
a similarity score computed based at least on a comparison between a vector representation of the query and vector representations of the document portions; and
an alignment score computed based at least on the degree of association between the attributes of the authors and the subject of the query.

11. The system of claim 9, the one or more processors further to:
compute a vector representation of the query and vector representations of the document portions;
determine semantic similarities between the query and the document portions based at least on a comparison of the vector representations; and
identify the plurality of document portions as being relevant to the query based at least on a determination that the semantic similarities between the query and the document portions meet or exceed a threshold.

12. The system of claim 9, the one or more processors further to compute, for the document portions, the relevance scores based at least on a graph data structure indicating relationships between the authors and a plurality of subjects.

13. The system of claim 9, wherein the ranking of the document portions comprises:
identifying one or more document portions having one or more scores that are less than a threshold; and
based at least on the one or more scores being less than the threshold, excluding the one or more document portions from being used to generate the response.

14. The system of claim 9, the one or more processors further to:
generate a first intermediate summary of a first subset of the document portions as ranked;
generate a second intermediate summary of a second subset of the document portions as ranked; and
generate, based at least on a combination of the first intermediate summary and the second intermediate summary, a final summary of the document portions,
wherein the output data is generated using the final summary of the document portions.

15. The system of claim 14, further comprising:
grouping the first subset of the document portions as ranked such that the first subset includes one or more first document portions associated with at least one of a first subject or a first entity; and
grouping the second subset of the document portions as ranked such that the second subset includes one or more second document portions associated with at least one of a second subject or a second entity.

16. The system of claim 9, wherein the generation of the output data comprises:
applying a prompt to a language model, the prompt including the query and a summary of the document portions; and
generating, using the language model and based at least on the prompt, the output data representing the response.

17. The system of claim 9, wherein the attributes of the authors include at least one of:
area of expertise;
expertise level,
subject association,
organizational position,
historical performance metrics, or
professional background information.

18. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

19. One or more processors comprising processing circuitry to:
store, in one or more data repositories, portions of documents in association with author information that is indicative of subject-specific expertise of authors of the portions of the documents, wherein the portions of the documents are indexed or grouped based at least on a relationship between an author of a specific portion of a document and one or more subjects associated with content included in the specific portion of the document.

20. The one or more processors of claim 19, the processing circuitry further to:
obtain, based at least on a determination that one or more portions of the documents are relevant to a query, the portions of the documents and the associated author information stored in the one or more data repositories;
compute, for the obtained portions of the documents, respective relevance scores based at least on a degree of association between attributes of the authors and a subject of the query;
rank the portions of the documents based at least on the relevance scores; and
generate output data representing a response to the query based at least on the ranking of the portions of the documents.
